(19) United States
(12) Patent Application Publication
(10) Pub. No.: US 2016/0348662 A1
(43) Pub. Date: Dec. 1, 2016

(54) Valve and Stop Arrangement for Reciprocating Compressor

(71) Applicant: WHIRLPOOL S.A., São Paulo, SP (BR)

(72) Inventor: Dietmar Erich Bernhard LILIE, Joinville (BR)

(73) Assignee: Whirlpool S.A., Sao Paulo (BR)

(21) Appl. No.: 15/115,080

(22) PCT Filed: Sep. 23, 2014
(86) PCT No.: PCT/BR2014/000343

§ 371 Date: Jul. 28, 2016

(30) Foreign Application Priority Data
Jan. 28, 2014 (BR) BR1020140021442

(51) Int. Cl. F04B 39/10; F16K 15/14; F04B 49/22

(52) U.S. Cl. CPC F04B 39/1073; F04B 49/22; F04B 39/1066; F16K 15/144; F04B 2201/06061

(57) ABSTRACT

The present invention relates to an arrangement integrated by at least one reed-type suction valve and at least one flexible stop which, arranged within the compression cylinder of the compressor, acts as end-of-stroke for the movement of said suction valve. Thus, flexible stop includes an angular inertial arrangement, so that it includes a free end spaced from the free end of suction valve. In addition, free end of flexible stop is cooperative to the movement of piston.

### FIELD OF THE INVENTION

The present invention relates to a valve and stop arrangement for reciprocating compressor, and more particularly, an arrangement integrated by at least one reed-type suction valve and at least one flexible stop which, arranged inside the compression cylinder of the compressor, acts as end-of-course for the movement of said suction valve.

According to the subject invention, said flexible stop aims to limit the opening degree of the suction valve without the movement of said suction valve is influenced before contact with said flexible stop.

### BACKGROUND OF THE INVENTION

As known by those technicians skilled in the subject matter, compressors comprise devices capable of altering the pressure of any working fluid.

More particularly, reciprocating compressors used in said refrigerating systems comprise devices capable of altering the pressure of a coolant fluid through the volumetric change of a compression cylinder in which said coolant fluid is inserted (under low pressure) and removed (under high pressure).

It is also known by the technicians skilled in the art that the insertion (or suction) of the coolant fluid occurs through at least one suction hole which is temporarily clogged by at least one suction valve. In contrast, the removal (or discharge) of the coolant fluid occurs through at least one discharge hole which is temporarily clogged by at least one discharge valve.

In more conventional embodiments thereof, the suction valves belonging to the current state of the art comprise reed-type valves, that is, resilient metal blades arranged under suction holes and housed inside the compression cylinder. In these cases, it is possible to consider such reed-type valves such as automatic valves, ultimately, the own suction pressure, inside the compression cylinder, causes the valves to unclog the suction holes thereof, while the own discharge pressure, within the compression cylinder, causes the valve to clog its suction holes.

In more conventional embodiments thereof, the discharge valves belonging to the current state of the art also comprises reed-type valves, but unlike the suction valves, they are housed outside the compression cylinder and, more particularly, inside an existing volume in the compression cylinder cover (or the discharge chamber).

A first differential characteristic between the reed-type suction valve and a reed-type discharge valve is related to the assembly difficulty of both.

The discharge valves, because they are outside the compression cylinder, can be mounted or integrated into a mounting arrangement essentially free of concerns related to interaction with the compression piston which moves inside the compression cylinder.

With this, it is common that discharge valves of compressors are mounted or integrated to a mounting arrangement provided with at least one fastening stop, which, besides acting as end-of-course for the valve opening degree, further acts as a valve fastening element to the valve-plate of the compressor. Non-exhaustive examples of this kind of reed-type discharge valves assembly are described in documents U.S. Pat. No. 4,714,416, CH597544, JP2002235660, U.S. Pat. No. 6,006,786 and PI8901306.

Interestingly, this concept can also be used in similar valves of internal combustion engines as disclosed in document U.S. Pat. No. 4,076,047.

As for the suction valves, since they are inside the compression cylinder, they are usually mounted or integrated to a mounting arrangement free of other elements arranged within the compression cylinder and, above all, free of fastened elements (such as discharge valve stops) arranged within the compression cylinder. This is because it becomes necessary—particularly for efficiency purposes—that the compression piston moves throughout the cylinder and the existence of additional elements and, in particular, fastened additional elements, could impair the displacement of the compression piston.

Thus, suction valves are usually mounted on or integrated to a mounting arrangement where fastening elements are provided arranged on the valve-plate.

It is also common that a reed-type suction valve is defined in a blade of geometry similar to the geometry of the valve-plate, so that the fastening of said suction valve occurs more easily and organically with said valve-plate.

It is known that in the past, it was used the suction valve with stop, however the stop was an edge in the recess of the cylinder and the valve had an extension entering this recess. However, this type of construction culminates in a considerable increase in the residual volume of the cylinder, with the piston advanced, affecting the specific capacity of the compressor and the efficiency thereof. Furthermore, because the extension of the valve comprises an additional mass, it also ultimately makes the handling thereof slower and less efficient than valves without stop.

On the other hand, it is within the knowledge of the technician skilled on the subject matter that reed-type suction valves tend to exhibit an oscillatory movement of “opening” and “closing” during a single suction cycle. This effect is better illustrated in the graph of FIG. 1.

As illustrated in FIG. 1, the initial “opening” degree of a reed-type suction valve (in normal conditions) comprises a driving peak that precedes an “almost closing”. After this peak, the opening degree of the suction valve tends to stabilize, and the valve enters in regime degree. Note that this entire movement of the suction valve occurs in each of the suction cycles, that is, several times each operating second of the compressor.

It is also worth noting that, from the functional point of view, there is not any benefit during the “opening” peak, after all, the suction hole is usually unclogged even when the suction valve enters in regime degree, that is, the passage area during the valve opening reaches a maximum within approximately one third of the maximum opening of the valve. This is due to the flow after certain valve opening is limited by the diameter of the hole, being the disturbance of the valve to the flow negligible.

Thus, the flow area, during the valve opening, has an asymptotic behavior and “open” the valve beyond this limit does not bring advantages to the compressor. On the contrary, the oscillation of the valve generates noise and may clog the fluid flow.

In consequence of this working state of the reed-type suction valve, it is common to scale the thickness and resilience thereof based on the “opening peak”. That is, it is common to oversize certain mechanical characteristics of the current reed-type suction valve according to their working states, without this causing any benefit to the functional or efficient dynamic of the compressor.

In order to avoid this problem, the current state of the art already includes some interesting and creative solutions.

Among these solutions, there is the one disclosed in document WO201208857, which requires the use of a suction valve consisting of two flexible reeds juxtaposed with each other in sliding manner, the use of lubricant means between said reeds being optionally provided.

In general, this solution describes a kind of suction valve with damping, where one of the reed sends up acting as inertial mass to the opening of the other. Thus, the reed facing the inner side of the compression cylinder acts as inertia mass to the opening of other reed, and the reed facing the valve-plate acts as inertia mass to the closing of the other reed.

Consequently, it is achieved a regime degree free of “opening” peaks of and “closing” peaks.

However, it was found—through functional tests—that the functional dynamics of the suction valve disclosed in document WO201208857 is extremely slow and inadequate for compressors operating at high working frequency.

This is because the “response time” of this suction valve, probably due to the inertial mass, presents delays in relation to the movement of the piston. Such “response time” is greatly hindered if lubrication is not used or lacked between the two reeds that make up this suction valve.

In addition, it is also noted that the fastening of this suction valve to the valve-plate is extremely laborious and, particularly, in the case of miniaturized compressors.

Thus, the present invention arises aiming to achieve benefits equivalent to the benefits reached by the suction valve disclosed in W0201208857, without observing the negatives aspects.

### OBJECTIVES OF THE INVENTION

Thus, it is an objective of the present invention to provide a valve and stop arrangement for reciprocating compressor able to mitigate the “opening peak” usually existing in the suction valve arrangements belonging to the current state of the art.

It is another objective of the present invention to provide a valve and stop arrangement for reciprocating compressor free of any kind of force inertial to the movement of the reed.

Thus, it is an objective of the subject invention to provide a valve and stop arrangement for reciprocating compressor provided with at least one flexible stop arranged inside the compression cylinder.

Finally, it is an objective of the subject invention that the flexible stop, so named, does not play any interference referring to the movement of the suction valve, except in the instance of occurring “opening peak” and/or “closing peak” thereof.

### SUMMARY OF THE INVENTION

These and other objectives of the invention now disclosed are fully achieved by the valve and stop arrangement for reciprocating compressor, the latter being formed by at least one compression cylinder, at least one piston and at least one reed-type suction valve, cooperating to at least one suction hole and arranged inside the compression cylinder.

According to the subject invention, the valve and stop arrangement of reciprocating compressor further comprises at least one flexible stop associated to the suction valve and arranged inside the compression cylinder. More particularly, the flexible stop comprises a reed type embodiment and an inertial arrangement in which the free end thereof lies remote from the free end of the suction valve. In addition, the free end of the flexible stop is especially cooperating to the movement of the piston.

Optionally, the stop and the valve arrangement for reciprocating compressor further comprises at least one dissipation means of dynamic energy associated to the flexible stop.

### BRIEF DESCRIPTION OF THE DRAWINGS

The invention will be described in detail based on the figures listed below, which:

FIG. 1 illustrates an diagrammatic chart related to the functional dynamics of the reed-type suction valves belonging to the current state of the art diagram;

FIG. 2 illustrates an diagrammatic chart related to the functional dynamics of the suction valve arrangement for reciprocating compressor according to the present invention;

FIG. 3 illustrates, diagrammatically, a side section of a compression cylinder composed by the preferred embodiment of the valve and stop arrangement for reciprocating compressor according to the present invention;

FIG. 4 illustrates, diagrammatically, a side section of a compression cylinder composed by the optional embodiment of the valve and stop arrangement for reciprocating compressor according to the present invention;

FIGS. 5A and 5B illustrate, respectively, the assembly of FIG. 3 in suction final condition and in discharge final condition; and

FIG. 6 illustrates a further detail introduced in the valve and stop arrangement for reciprocating compressor according to the present invention.

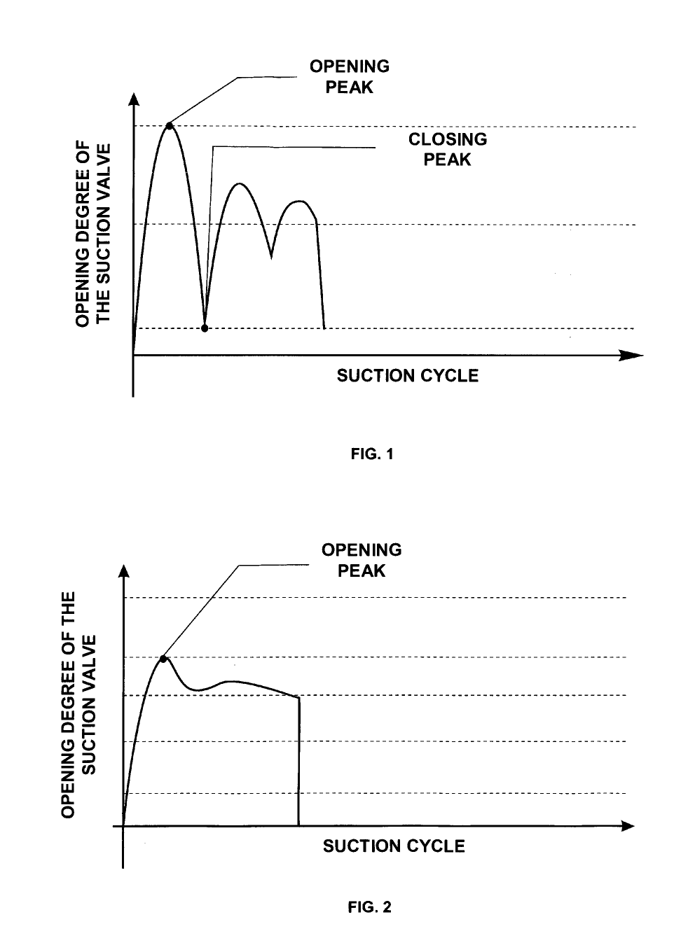

### DETAILED DESCRIPTION OF THE INVENTION

Based on the objectives of the subject invention, it is then presented a new valve and stop arrangement for reciprocating compressor.

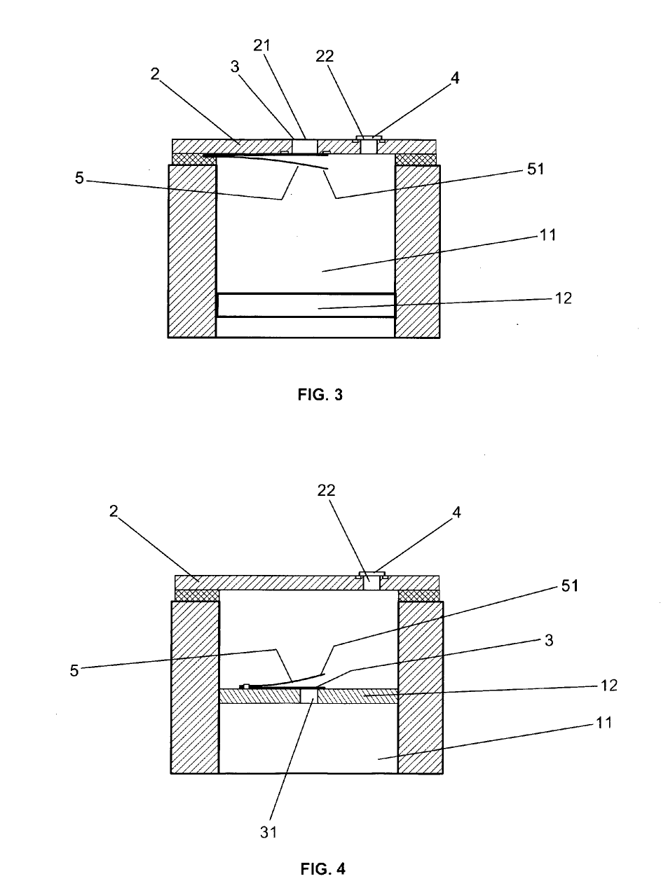

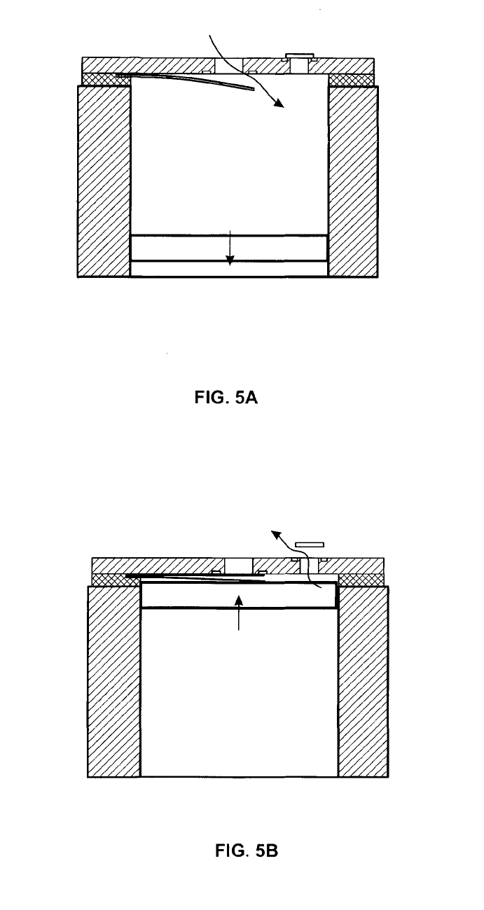

As illustrated in FIG. 3, it is seen that the preferred embodiment of the valve and stop arrangement for reciprocating compressor is especially adaptable to an reciprocating compressor whose compression mechanism includes a compression cylinder 11, a piston 12 and a valve-plate 2 comprising at least one suction hole 21 and at least one discharge hole 22.

All these components, therein including different constructive versions, belong to the current state of the art and they are widely disclosed in particular literature.

The valve and stop arrangement itself includes a reed-type suction valve 3 and a flexible stop 5. In addition, and for obvious reasons, and is further provided for a reed-type discharge valve 4. In this context, it is also worth mentioning that reed-type suction valves and discharge valves are used in reciprocating compressors. It means that different ways of forming and fastening the reed-type valves are within the knowledge of the technicians skilled in the art.

Anyway, it is emphasized that suction valve 3 is cooperative to suction hole 21 of valve-plate 2, and it is arranged within compression cylinder 1.

Discharge valve 4, in turn, is cooperative to discharge hole 22 of valve-plate 2, and it is arranged outside compression cylinder 1.

The valve and to stop arrangement for reciprocating compressor, the object of the subject invention, is noted to present a flexible stop 5, which comprises a reed type embodiment (equivalent to valves 3 and 4) and an specific inertial arrangement, so as to comprises a free end 51 away from the free end of suction valve 3.

Obviously, flexible stop 5 as well as suction valve 3 are arranged inside compression cylinder 1, both fixed to valve-plate 2, being this latter physical arrangement achieved by means already known and/or used to the arrangement/fastening of suction valve 3 to valve-plate 2.

As an example, it is noted that both suction valve 3 and flexible stop 5 can each comprise a kind of mobile pallet set in a metal blade of dimensions similar to the dimensions of valve-plate 2, the fastening between these three elements being accomplished by conventional fastening means (as normally happens with conventional suction valves).

It is important to emphasize that, in accordance with the subject invention, flexible stop 5 is made/obtained in order to comprise one free end 51pre-stressed. Thus, when suction valve 3 and flexible stop 5 are mounted inside compression cylinder 1, said free end 51 of flexible stop 5 is spaced apart and/or spaced from the free end of the suction valve 3.

In the constructive example mentioned above, both suction valve 3 and flexible stop 5 can be obtained by stamping processes, the difference between both being solely the fact that flexible stop 5 is stamped with free end thereof 51pre-deformed, or pre-folded, while the suction valve is stamped in a planned manner.

Still according to the present invention, it is further noted that free end 51 of flexible stop 5 is cooperating to the movement of piston 12, that is, free end 51 of flexible stop 5 is capable of movement driven by the contact with piston 12 during the discharge cycles of the reciprocating compressor.

Once flexible stop 5 has one free end 51pre-deformed, it is also noted that said free end 51 tends to return to the inertial position thereof (“normal” position) when there is no contact with piston 12 during the suction cycles of the reciprocating compressor.

Therefore, it is emphasized that flexible stop 5 comprises an inertial arrangement 5, that is, an originally angular arrangement (relative to the plane of suction valve 3 and/or relative to the plane of piston 12) that is changed from an external force (in this case, the force exerted by piston 12) and tends to return to the initial position in the absence of external force.

As shown in FIG. 4, there is an optional embodiment where suction hole 31, instead of being defined on valve-plate 2, is defined in piston 12. Consequently, suction valve 3 is cooperative to suction hole 31 defined in piston 12.

Thus, it is also noted that suction valve 3 and flexible stop 5 are fixed to piston 12 (by conventional fastening means), while free end 51 of flexible stop 5 is cooperating to the movement of piston 12 due to the physical contact between said free end 51 and valve-plate 2.

Anyway, regardless the preferred embodiment of FIG. 3 or the optional embodiment of FIG. 4, flexible stop 5 has a geometry analogous to the geometry of suction valve 3 (regardless specific geometries), and comprises a thickness greater than the thickness of suction valve 3.

Because of this, said flexible stopper 5 ends up acting as a kind of end-of-course, defining the maximum stroke of movement of suction valve 3 during the suction cycles of the reciprocating compressor. Thus, all the problems related to the “opening” peak of suction valve 3 is solved in a simple way, namely by setting the angle of the inertial provision of flexible stop 5.

The distance from flexible stop 5 to suction valve 3 is set in order to limit the opening of the valve to the balance position of the valve, which is close to the average valve opening.

As flexible stop 5 is thicker than suction valve 3, the movement of the latter tends to not alter the originally angular arrangement of flexible stop 5.

It is evident that small movements can occur with envisaged situations, therefore, and to a lesser degree of interaction, one can also say that the free end of flexible stop 5 can be also the cooperative to the movement of suction valve 3.

The implementation of flexible stop 5, inside compression cylinder 1, with free end 51 spaced from the free end of suction valve 3 and cooperative to the movement of piston 12, causes the movement of suction valve 3, during suction cycles, to be limited, avoiding the occurrence of “opening” peaks and, consequently, avoiding harms caused by this behavior.

One of the great challenges of the subject invention further consists of keeping an additional component, in this case the own flexible stop 5, inside the compression cylinder 1.

This challenge is overcome by the fact that said flexible stopper 5 is, in addition to flexible, provided with high mechanical resilience.

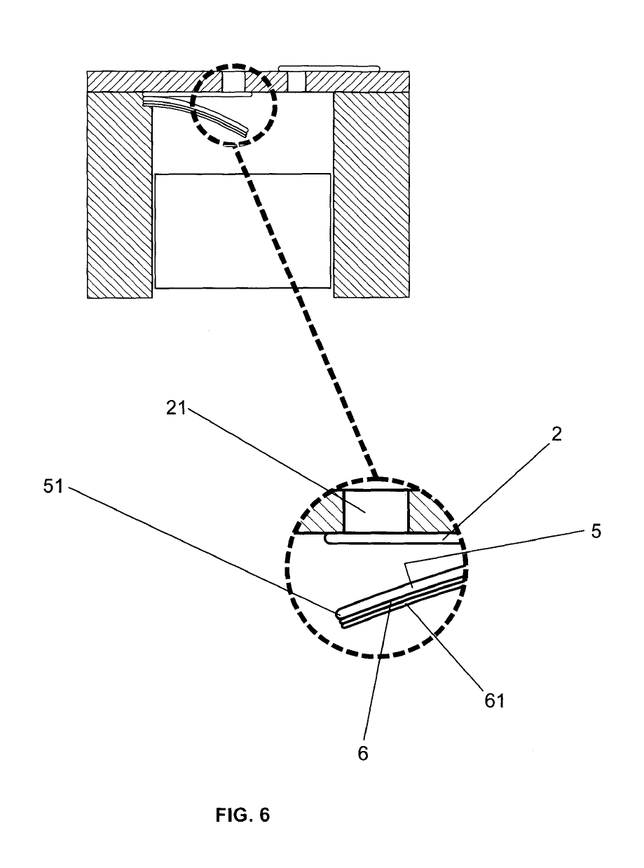

In addition, and as illustrated in FIG. 6, this challenge can also be overcome with the addition of means 6 of dynamic energy dissipation associated to the flexible stop 5, which comprises a layer of viscoelastic material associated to the flexible stop 5.

The addition of this material is shown to be beneficial because it increases the impact absorption capacity of flexible stop 5, thus increasing its service life and reducing the friction wear between piston 12 and valve-plate 2 (depending on the preferred or optional embodiment of the invention) and free end 51 of flexible stop 5.

Preferably, the viscoelastic material layer 6 further comprises at least one support structure 61, which comprises a fastening means and more particularly a fastening means non-injurious to the dynamic of the reciprocating compressor.

Having described an example of the preferred embodiment of the valve and stop arrangement for reciprocating compressor, it should be understood that the scope of the present invention covers other possible variations, which are solely limited by the content of the claims, including therein the possible equivalents means.

1. Reciprocating compressor provided with a valve and stop arrangement, the compressor comprising:
at least one compression cylinder and at least one piston;
at least one reed-type suction valve, cooperating to the at least one suction hole and arranged inside the compression cylinder;
at least one flexible stop associated to the suction valve and arranged within compression cylinder;
the flexible stop comprising a reed-type embodiment;
the flexible stop comprising an inertial arrangement wherein the free end thereof is spaced from the free end of the suction valve; and
the free end of the flexible stop being cooperative to the movement of the piston;
the reciprocating compressor being characterized in that it comprises;
at least one means of dynamic energy dissipation associated to the flexible stop;
said means of dynamic energy dissipation comprises a viscoelastic material layer associated to the flexible stop.

2. Valve and stop arrangement for reciprocating compressor according to claim 1, characterized in that the suction valve is cooperative to the suction hole defined in a valve-plate.

3. Valve and stop arrangement for reciprocating compressor according to claim 2, characterized in that the suction valve and the flexible stop are fastened to the valve-plate.

4. Valve and stop arrangement for reciprocating compressor according to claim 2, characterized in that the free end of the flexible stop is cooperative to the movement of the piston depending on the physical contact between said free end and the piston.

5. Valve and stop arrangement for reciprocating compressor according to claim 1, characterized in that the suction valve is cooperative to the suction hole defined in the piston.

6. Valve and stop arrangement for reciprocating compressor according to claim 5, characterized in that the suction valve and the flexible stop are fastened to the piston.

7. Valve and stop arrangement for reciprocating compressor according to claim 4, characterized in that the free end of the flexible stop is cooperative to the movement of the piston due to the physical contact between said free end and the valve-plate.

8. Valve and stop arrangement for reciprocating compressor according to claim 1, characterized in that the free end of flexible stop is also cooperative to the movement of the suction valve.

9. Valve and stop arrangement for reciprocating compressor according to claim 1, characterized in that the flexible stop comprises a geometry analogous to the geometry of the suction valve.

10. Valve and stop arrangement for reciprocating compressor according to claim 1, characterized in that the flexible stop comprises a thickness higher than the thickness of the suction valve.

11. (canceled)

12. (canceled)

13. Valve and stop arrangement for reciprocating compressor according to claim 1, characterized in that the layer of viscoelastic material further comprises at least one support structure.

14. Valve and stop arrangement for reciprocating compressor according to claim 1, characterized in that the flexible stop defines the maximum stroke of movement of the suction valve.
